(19) United States
(12) Patent Application Publication
(10) Pub. No.: US 2026/0084632 A1
(43) Pub. Date: Mar. 26, 2026

(54) Modular Vehicle License Plate Tag Protection Kit

(71) Applicant: Agustin M. Latosquin, III, Beaumont, CA (US)

(72) Inventor: Agustin M. Latosquin, III, Beaumont, CA (US)

(21) Appl. No.: 19/171,426

(22) Filed: Apr. 7, 2025

Related U.S. Application Data
(60) Provisional application No. 63/698,083, filed on Sep. 24, 2024.

(51) Int. Cl. B60R 13/10

(52) U.S. Cl. CPC B60R 13/10

(57) ABSTRACT

The present invention is a vehicle license plate tag protection kit to safeguard vehicle registration stickers from theft, environmental damage, and debris while maintaining full visibility of the stickers and license plate number. The kit includes an interchangeable clear and molded plastic frame configured to cover either the top, bottom, or corner sections (i.e., partial sections) of a license plate, depending on sticker placement requirements. The frame features pre-drilled apertures aligned with existing mounting holes on the license plate, enabling secure installation using included fasteners. In one embodiment, the frame includes an outer scratch-resistant and UV-stabilized hydrophobic layer, an impact-resistant middle layer, and a friction adhesion inner layer. The kit provides compatibility with license plates of various shapes and sizes and adherence to state-specific regulations.

### CROSS-REFERENCE TO RELATED APPLICATION

The present application claims priority to, and the benefit of, U.S. Provisional Application No. 63/698,083 which was filed on Sep. 24, 2024, and is incorporated herein by reference in its entirety.

### FIELD OF THE INVENTION

The present invention generally relates to protective accessories for vehicle license plates. More specifically, the invention relates to a vehicle license plate tag protection kit designed to safeguard registration stickers from theft, environmental damage, and debris while maintaining visibility for compliance with legal requirements. The kit includes a clear, molded plastic frame. The frame includes pre-drilled apertures aligned with existing license plate mounting holes, enabling secure installation using fasteners. The kit includes modular frames for top, bottom, or corner protection, accommodating various state-specific sticker placement configurations. Accordingly, the present disclosure makes specific reference thereto. Nonetheless, it is to be appreciated that aspects of the present invention are also equally applicable to other like applications, devices, and methods of manufacture.

### BACKGROUND

By way of background, license plates are essential for vehicle identification and registration. Further, license plates have affixed month and year registration/renewal stickers for indicating valid registration periods. These stickers play an important role in enabling law enforcement to verify a vehicle's compliance with state regulations quickly. However, these stickers are constantly exposed to outdoor weather elements such as rain, snow, and UV radiation, which can lead to fading, peeling, or deterioration over time. Additionally, dirt, mud, and other debris can obscure the stickers, making them difficult to read.

Another significant issue is the risk of sticker theft. Stolen stickers can be illegally transferred to unregistered or stolen vehicles, complicating law enforcement efforts and causing inconvenience to the vehicle owner. Existing license plate covers enclose the entire plate, including its identification numbers and are prohibited in many jurisdictions. Conventional covers obstruct the visibility of the license plate number, which is a legal requirement, leading to potential citations by law enforcement. Individuals desire a solution that protects registration stickers without violating visibility regulations or impeding the identification of license plates.

Therefore, there exists a long-felt need in the art for a vehicle license plate tag protection kit that effectively safeguards registration stickers from theft and environmental damage. Specifically, there is a long-felt need for a solution that prevents stickers from peeling, fading, or becoming illegible due to exposure to weather elements. Additionally, there is a need for a system that protects stickers from dirt, mud, and debris while maintaining their visibility for law enforcement and regulatory compliance. Furthermore, there exists a long-felt need for a kit that reduces the risk of theft, ensuring that registration stickers remain securely affixed to the license plate. Moreover, there is a long-felt need for a protection system that complies with legal requirements by not obstructing license plate numbers or identification features. Finally, there is a need for a modular and user-friendly kit that can adapt to various license plate sizes and state-specific sticker placement requirements, offering vehicle owners a simple and efficient solution to protect their registration stickers.

The subject matter disclosed and claimed herein, in one embodiment, comprises a vehicle license plate tag protection kit. The kit includes a clear, incompressible, and molded plastic frame designed to safeguard registration stickers affixed to a license plate. The frame features pre-drilled apertures aligned with existing mounting holes on the license plate, enabling secure installation using fasteners included in the kit. The frame comprises an outer UV-stabilized, hydrophobic layer to prevent yellowing and degradation, a middle impact-resistant polymer layer, and an inner friction adhesion layer to ensure a snug, non-slip fit. In some embodiments, the inner layer integrates a tamper-detection sensor capable of sending notifications to a remote device if the frame is tampered with. The kit includes modular frames designed to protect stickers on the top, bottom, or corners of the license plate, accommodating various state-specific placement requirements.

In this manner, the vehicle license plate tag protection kit of the present invention fulfills the aforementioned needs by providing a robust solution for protecting registration stickers from environmental exposure, theft, and debris. The modular design enables users to select frames tailored to their specific license plate configurations and sticker placement requirements. The kit enables users to bolt the cover on over the plate, utilizing a transparent plastic material to ensure the month and year registration/renewal stickers remain visible for vehicle identification.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle license plate tag protection kit. The kit comprises a clear, incompressible, and molded plastic frame configured to protect vehicle registration stickers affixed to a license plate, a plurality of pre-drilled apertures are disposed or positioned along at least one edge of the frame, the apertures being aligned with mounting holes of the license plate, a plurality of fasteners are configured to pass through the pre-drilled apertures and the mounting holes of the license plate for securely mounting the frame, wherein the frame shields the registration stickers from theft, environmental exposure, and debris while maintaining visibility of the stickers and the license plate number.

In another embodiment, a vehicle license plate tag protection kit is disclosed. The kit includes a set of interchangeable clear plastic frames configured to protect registration stickers affixed to different sections of a license plate, the set comprising a top section frame with pre-drilled apertures for mounting along the top edge of the license plate, a bottom section frame with pre-drilled apertures for mounting along the bottom edge of the license plate, a corner cover with an aperture for mounting over a sticker placed at a corner of the license plate, a plurality of fasteners are configured to securely attach the frames to the license plate through the pre-drilled apertures, wherein the kit provides modular protection for license plate stickers, shields the stickers from theft and environmental exposure, and complies with state-specific requirements for license plate designs.

In another aspect, a vehicle license plate tag protection kit is disclosed. The vehicle license plate tag protection kit includes a clear frame configured to cover either a top section or a bottom section of a license plate. The frame has a top edge, a bottom edge, and a pair of side edges, wherein the top edge or bottom edge aligns with the corresponding edge of the license plate. At least a pair of pre-drilled apertures are disposed or positioned along the edge of the frame configured to align with mounting holes on the license plate for installation using fasteners. The frame is resistant to environmental exposure, including rain, snow, and UV light, and does not obstruct the visibility of the license plate number or registration stickers affixed to the plate.

In one embodiment, a vehicle license plate tag protection kit is disclosed. The vehicle license plate tag protection kit includes a corner cover designed to protect registration stickers affixed at any of the four corners of a license plate, the corner cover includes a clear plastic material with at least one aperture disposed or positioned near a corner of the cover, the aperture is configured to align with a mounting hole of the license plate, a fastener is configured to pass through the aperture and the mounting hole for securing the cover to the license plate, and the corner cover shields the sticker from theft, environmental elements, and debris without obstructing visibility of the sticker or the license plate number.

In yet another aspect, a vehicle license plate tag protection kit is disclosed. The kit includes a clear plastic frame comprising an outer scratch-resistant and UV-stabilized hydrophobic layer configured to prevent yellowing or degradation of the frame, a middle impact-resistant polymer layer configured to resist physical impacts, an inner friction adhesion layer configured to provide an anti-slip snug fit to a license plate, the frame further includes a tamper-detection sensor integrated within the inner layer, the sensor being configured to detect tampering with the frame and transmit a notification to a remote device, wherein the frame is mountable onto a license plate using fasteners and shields the registration stickers from environmental exposure and theft while maintaining visibility.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of vehicle license plate tag protection kit of the present invention in accordance with the disclosed architecture;

FIG. 2 illustrates a perspective view showing the vehicle license plate tag protection kit of the present invention installed on a top section (i.e., partial coverage) of a license plate to protect the vehicle tag stickers in accordance with the disclosed structure;

FIG. 3 illustrates a perspective view showing the alignment of the pre-drilled apertures with the license plate for installation in accordance with the disclosed structure;

FIG. 4 illustrates a perspective view of another embodiment of the clear frame used for covering the license plate tags in accordance with the disclosed structure;

FIG. 5 illustrates a perspective view showing how the bottom section frame of FIG. 4 is mounted to the license plate for installation in accordance with the disclosed structure;

FIG. 6 illustrates another embodiment of the license plate tag cover in accordance with the disclosed structure;

FIG. 7 illustrates a perspective view showing how the sticker cover of FIG. 6 is used with a license plate in accordance with one embodiment of the present invention; and

FIG. 8 illustrates a cross-section view of the license plate covering frame in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle license plate tag protection kit that effectively safeguards registration stickers from theft and environmental damage. Specifically, there is a long-felt need for a solution that prevents stickers from peeling, fading, or becoming illegible due to exposure to weather elements. Additionally, there is a need for a system that protects stickers from dirt, mud, and debris while maintaining their visibility for law enforcement and regulatory compliance. Furthermore, there exists a long-felt need for a kit that reduces the risk of theft, ensuring that registration stickers remain securely affixed to the license plate. Moreover, there is a long-felt need for a protection system that complies with legal requirements by not obstructing license plate numbers or identification features. Finally, there is a need for a modular and user-friendly kit that can adapt to various license plate sizes and state-specific sticker placement requirements, offering vehicle owners a simple and efficient solution to protect their registration stickers.

The present invention, in one exemplary embodiment, is a vehicle license plate tag protection kit. The kit includes a set of interchangeable clear plastic frames configured to protect registration stickers affixed to different sections of a license plate, the set comprising a top section frame with pre-drilled apertures for mounting along the top edge of the license plate, a bottom section frame with pre-drilled apertures for mounting along the bottom edge of the license plate, a corner cover with an aperture for mounting over a sticker placed at a corner of the license plate, a plurality of fasteners are configured to securely attach the frames to the license plate through the pre-drilled apertures, wherein the kit provides modular protection for license plate stickers, shields the stickers from theft and environmental exposure.

Reference will now be made in detail to the present preferred embodiments of the invention, examples of which are illustrated in the accompanying drawings. Wherever possible, the same reference numerals are used in the drawings and the description to refer to the same or like parts.

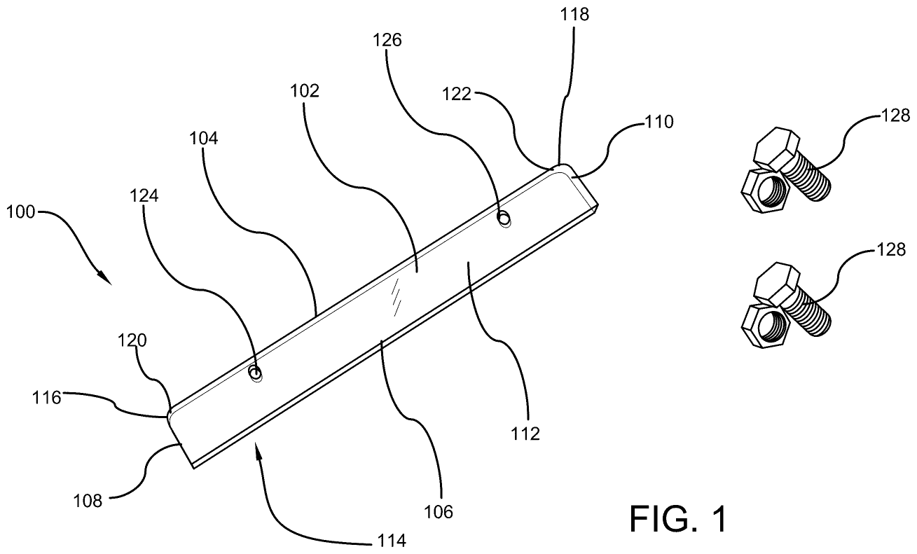

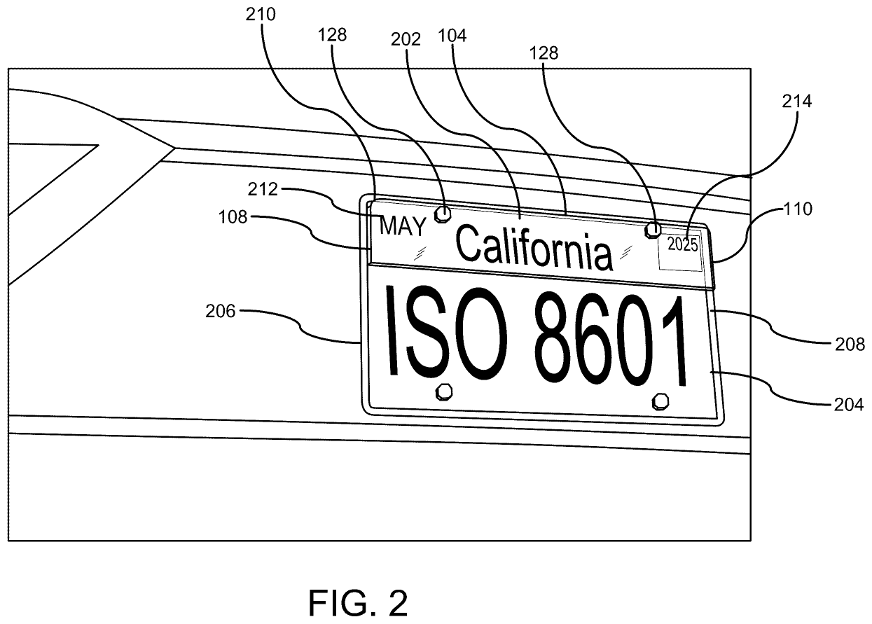

Referring initially to the drawings, FIG. 1 illustrates a perspective view of vehicle license plate tag protection kit of the present invention in accordance with the disclosed architecture. The vehicle license plate tag protection kit 100 of the present invention is designed as a clear plastic barrier to safeguard vehicle registration stickers affixed to license plates. The vehicle registration stickers commonly display year and month information. The vehicle license plate tag protection kit 100 includes an incompressible and molded clear frame 102 which is preferably made of a durable and transparent material. The clear plastic frame 102 is designed to protect the stickers affixed along, or proximal to, the top edge of a license plate as illustrated in FIG. 2. The clear plastic frame 102 is resistant to wear and tear from environmental exposure. The clear frame 102 includes a top edge 104, a bottom edge 106, and a pair of side edges 108, 110. An outer side 112 of the frame 102 disposes away from a license plate and an inner side 114 of the frame 102 is for disposal adjacent to the license plate. Both the outer side 112 and the inner side 114 are planar and conforms to the planar surface of conventional license plates. For conforming to the shape of conventional vehicle license plates, opposing rounded corners 116, 118 are disposed or positioned on opposing ends 120, 122 of the top edge 104.

A plurality of apertures 124, 126 are disposed or positioned, in one exemplary embodiment, along the top edge 104 wherein the apertures 124, 126 are pre-drilled and are aligned for mounting the frame 102 to and with the existing license plate to the vehicle. A plurality of fasteners 128 are included in the kit 100 and can be bolted down securely through the apertures 124, 126 for installing the frame 102 on the license plate. It should be noted that the frame 102 shields registration stickers from being peeled off or stolen and guards against weather elements such as rain, snow, and UV exposure. The clear frame 102 does not obstruct visibility of the stickers and license plate number and can be designed in different sizes to be compatible with license plates of different sizes and shapes.

FIG. 2 illustrates a perspective view showing the vehicle license plate tag protection kit of the present invention installed on a top section (i.e., partial coverage) of a license plate to protect the vehicle tag stickers in accordance with the disclosed structure. The frame 102 is positioned along the top section 202 of the license plate 204 such that the side edges 108, 110 of the frame 102 align along the side edges 206, 208 of the license plate 204 and the top edge 104 of the frame 102 aligns with the top edge 210 of the license plate 204. The top edge 104 extends around all or substantial portion of the top edge 210 of the license plate 204.

The frame 102 is mounted using the fasteners 128 such as bolts which pass through the plurality of the pre-drilled apertures 124, 126 and fasten, with the license plate 204, to the vehicle. The frame 102 partially covers the license plate 204 while completely or fully covering the month tag 212 and the year tag 214 affixed to the license plate 204 such as required in California license plates. The frame 102 can also be removed easily from the license plate 204, by unfastening the fasteners 128 such as for replacing the year tag 214. The fasteners 128 are passed from the outer side 112 towards the inner side 114 of the frame 102 and are fastened with the license plate 204 to the vehicle.

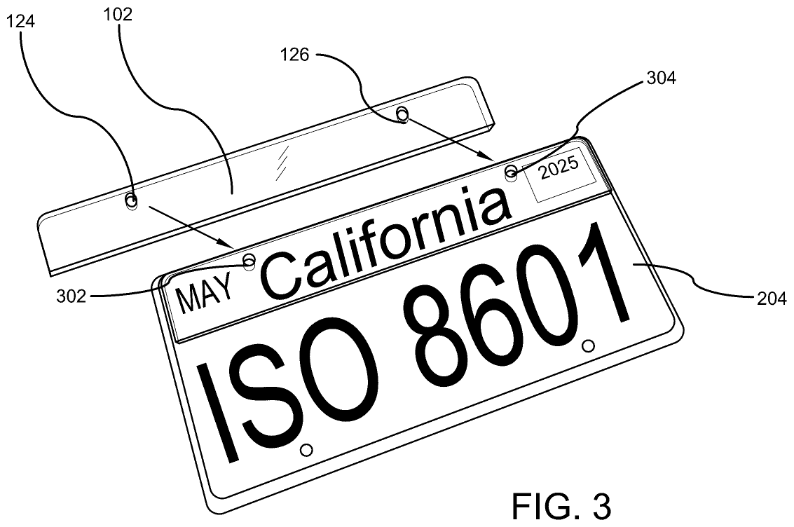

FIG. 3 illustrates a perspective view showing the alignment of the pre-drilled apertures with the license plate for installation in accordance with the disclosed structure. As illustrated, a pair of holes 302, 304 are disposed or positioned on the top section 202 of the license plate 204 and for mounting the clear frame 102, the pre-drilled apertures 124, 126 are aligned with the mounting holes 302, 304 enabling the fasteners 128 to pass through the sets of pre-drilled apertures 124, 126 and the mounting holes 302, 304. It should be noted that no additional drilled holes are needed in the license plate and the vehicle for installation of the frame 102.

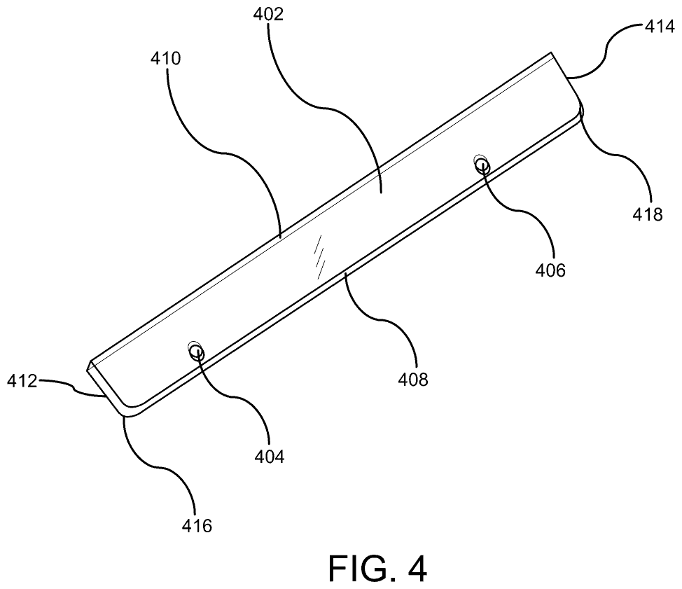

FIG. 4 illustrates a perspective view of another exemplary embodiment of the clear frame used for covering the license plate tags in accordance with the disclosed structure. In the present embodiment, the frame 402 is designed to cover the bottom section of a license plate (i.e., partially cover the license plate) wherein the license plate stickers are affixed and completely or fully covered by the frame 402 along the bottom edge of the license plate such as on the license plate issued according to Wisconsin law. As illustrated, the frame 402 includes at least a pair of pre-drilled holes 404, 406 along the bottom edge 408 of the frame 402 for receiving the fasteners 128. The frame 402 is rectangular and has a top edge 410 and a pair of side edges 412, 414 to conform to the size of conventional license plates. Further, the opposing ends of the bottom edge 408 have rounded corners 416, 418 to conform to the shape of the license plate.

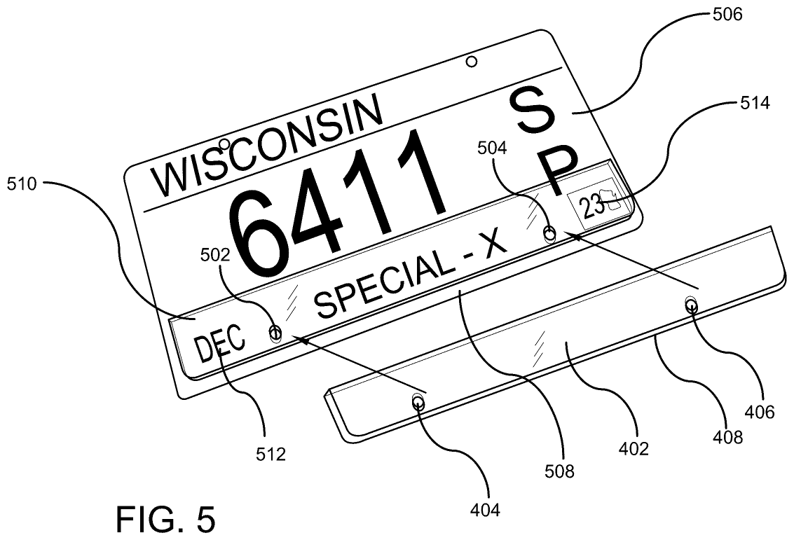

FIG. 5 illustrates a perspective view showing how the bottom section frame of FIG. 4 is mounted with the license plate for installation in accordance with the disclosed structure. The frame 402 is positioned such that the pre-drilled holes 404, 406 are aligned to the mounting holes 502, 504 of the license plate 506. The bottom edge 408 of the frame 402 coincides with the bottom edge 508 of the license plate 506 and the frame 402 covers the bottom section 510 of the license plate 506 while completely or fully covering the month tag 512 and the year tag 514. The frame 402 protects the tags 512, 514 from weather elements such as rain, snow, and UV exposure, which can deteriorate sticker adhesive or legibility over time while maintaining visibility of the tags 512, 514.

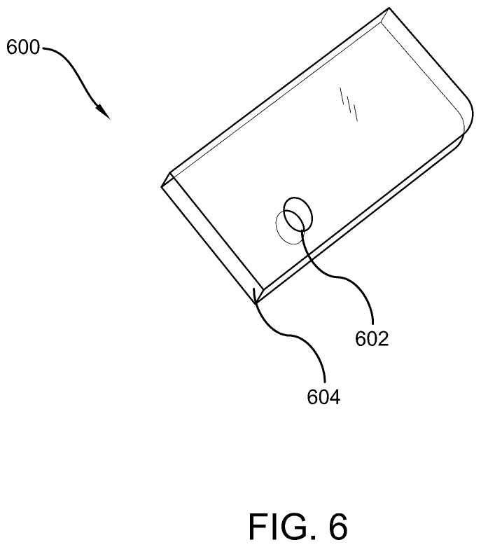

FIG. 6 illustrates another embodiment of the license plate tag cover in accordance with the disclosed structure. In the present embodiment, the cover 600 is in the form a rectangle and has one aperture 602. The aperture 602 is disposed or positioned near a corner 604 of the cover 600. In different embodiments, the aperture 602 can be disposed or positioned near any of the corners enabling a user to mount the cover 600 along one of the corners of a license plate. The cover 600 is designed to provide complete coverage and protection to a sticker placed at any of the four corners of the license plate.

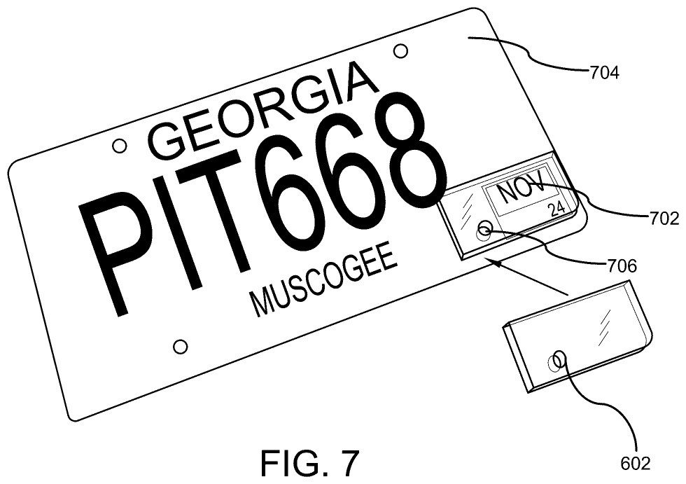

FIG. 7 illustrates a perspective view showing how the sticker cover of FIG. 6 is used with a license plate in accordance with one embodiment of the present invention. As illustrated, depending on the position of the sticker 702 on the license plate 704, the cover 600 is positioned to align the aperture 602 with the mounting hole 706 of the license plate 704. The cover 600 overlaps the sticker 702 and is fastened using a fastener included in the kit of the present invention.

It should be noted that the durable and transparent license plate sticker protection system 100 may include the vehicle license plate tag frames for top section, bottom section, and corners of license plates. Further, a plurality of fasteners such as bolts are included in kit, enabling users to mount the cover without any professional help. Different frames provide compliance with state regulations of different states.

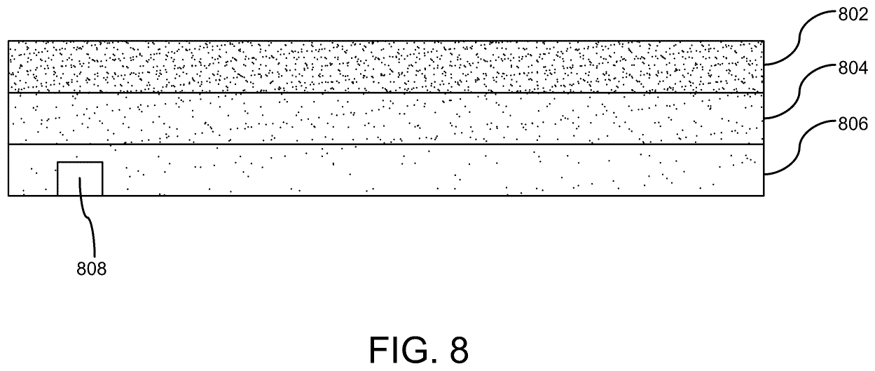

FIG. 8 illustrates a cross-section view of the license plate covering frame in accordance with one embodiment of the present invention. In the present embodiment, the frame 800 includes an outer scratch-resistant and UV-stabilized hydrophobic layer 802 which prevents yellowing or degradation of the frame 800 over time. A middle layer 804 is made from impact-resistant polymers which prevents the frame 800 from breaking upon physical impact. The inner layer 806 is a friction adhesion layer and provides an anti-slip snug fit to a license plate. The inner layer 806 may also include a tamper-detection sensor 808 for detecting tampering with the cover 800 and a notification may be sent to a remote device such as device of owner of the vehicle. The sensor 808 can be in the form of an RFID chip.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle license plate tag protection kit”, “durable and transparent license plate sticker protection system”, “modular vehicle license plate tag protection kit”, and “kit” are interchangeable and refer to the modular vehicle license plate tag protection kit 100 of the present invention.

Notwithstanding the forgoing, the modular vehicle license plate tag protection kit 100 of the present invention can be of any suitable configuration as is known in the art without affecting the overall concept of the invention, provided that it accomplishes the above stated objectives. One of ordinary skill in the art will appreciate that the modular vehicle license plate tag protection kit 100 as shown in the FIGS. are for illustrative purposes only, and that many other configurations of the modular vehicle license plate tag protection kit 100 are well within the scope of the present disclosure. Although the dimensions of the modular vehicle license plate tag protection kit 100 are important design parameters for user convenience, the modular vehicle license plate tag protection kit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle license plate tag protection kit comprising:
a license plate;
a license plate protector having a molded frame and a plurality of apertures; and
a license plate sticker;
wherein said molded frame having a UV-stabilized hydrophobic outer layer, an impact-resistant polymer middle layer, and a friction adhesion inner layer;
wherein said molded frame is transparent;
wherein said molded frame having a top edge, a bottom edge, a first side edge, a second side edge, a planar outer side, and a planar inner side;
wherein said planar outer side and said planar inner side conforms to the planar surface of said license plate;
wherein said license plate sticker affixed proximal to an edge of said license plate; and
further wherein said molded frame partially covers said license plate and fully covers at least one of said license plate sticker affixed on said license plate.

2. The vehicle license plate tag protection kit of claim 1, wherein said molded frame fully covers at least two of said license plate stickers affixed on said license plate.

3. The vehicle license plate tag protection kit of claim 2, wherein said plurality of apertures positioned along said top edge.

4. The vehicle license plate tag protection kit of claim 3, wherein said plurality of apertures aligned with mounting holes of said license plate.

5. The vehicle license plate tag protection kit of claim 4, wherein said first side edge of said molded frame aligned along a first side edge of said license plate and said second side edge of said molded frame aligned along a second side edge of said license plate.

6. The vehicle license plate tag protection kit of claim 5, wherein said top edge of said molded frame aligned along a top edge of said license plate.

7. A vehicle license plate tag protection kit comprising:
a license plate;
a license plate protector having a molded frame and a plurality of apertures; and
a license plate sticker;
wherein said molded frame is transparent;
wherein said molded frame having a top edge, a bottom edge, a first side edge, a second side edge, a planar outer side, and a planar inner side;
wherein said planar outer side and said planar inner side conforms to the planar surface of said license plate;
wherein said license plate sticker affixed proximal to an edge of said license plate; and
further wherein said molded frame partially covers said license plate and fully covers at least two of said license plate sticker affixed on said license plate.

8. The vehicle license plate tag protection kit of claim 7, wherein said molded frame having a UV-stabilized hydrophobic outer layer, an impact-resistant polymer middle layer, and a friction adhesion inner layer.

9. The vehicle license plate tag protection kit of claim 8, wherein said plurality of apertures positioned along said top edge.

10. The vehicle license plate tag protection kit of claim 9, wherein said plurality of apertures aligned with mounting holes of said license plate.

11. The vehicle license plate tag protection kit of claim 10, wherein said first side edge of said molded frame aligned along a first side edge of said license plate and said second side edge of said molded frame aligned along a second side edge of said license plate.

12. The vehicle license plate tag protection kit of claim 11, wherein said top edge of said molded frame aligned along a top edge of said license plate.

13. A vehicle license plate tag protection kit comprising:
a license plate having a mounting hole;
a license plate protector kit having a molded frame, an aperture, and a fastener; and
a license plate sticker;
wherein said molded frame is transparent;
wherein said molded frame having a top edge, a bottom edge, a first side edge, a second side edge, a planar outer side, and a planar inner side;
wherein said planar outer side and said planar inner side conforms to the planar surface of said license plate;
wherein said license plate sticker affixed proximal to an edge of said license plate;
wherein said fastener extending through said aperture of said molded frame and extending through said mounting hole of said license plate;
wherein said fastener mounted to a vehicle; and
further wherein said molded frame partially covers said license plate and fully covers said license plate sticker affixed on said license plate.

14. The vehicle license plate tag protection kit of claim 13, wherein said molded frame having a UV-stabilized hydrophobic outer layer, an impact-resistant polymer middle layer, and a friction adhesion inner layer.

15. The vehicle license plate tag protection kit of claim 14, wherein said license plate having another mounting hole and said molded frame having another aperture;
wherein said license plate protector kit having another fastener;
wherein said another fastener extending through said another aperture of said molded frame and extending through said another mounting hole of said license plate; and
further wherein said another fastener is fastened to the vehicle.

16. The vehicle license plate tag protection kit of claim 15, wherein said aperture and said another aperture positioned along said top edge.

17. The vehicle license plate tag protection kit of claim 16, wherein said aperture and said another aperture aligned with said mounting hole and said another mounting hole of said license plate.

18. The vehicle license plate tag protection kit of claim 17, wherein said first side edge of said molded frame aligned along a first side edge of said license plate and said second side edge of said molded frame aligned along a second side edge of said license plate.

19. The vehicle license plate tag protection kit of claim 18, wherein said top edge of said molded frame aligned along a top edge of said license plate.

20. The vehicle license plate tag protection kit of claim 18, wherein said molded frame fully covers at least another license plate sticker affixed on said license plate.
